(19) United States
(12) Patent Application Publication
(10) Pub. No.: US 2025/0243961 A1
(43) Pub. Date: Jul. 31, 2025

(54) VENT PIPE END STRUCTURE

(71) Applicant: SUBARU CORPORATION, Tokyo (JP)

(72) Inventors: Junichi ISHIHARA, Tokyo (JP); Hideaki HATAKENAKA, Tokyo (JP); Hiroshi TAKAHASHI, Tokyo (JP); Tetsuya KANEKO, Tokyo (JP)

(73) Assignee: SUBARU CORPORATION, Tokyo (JP)

(21) Appl. No.: 19/024,440

(22) Filed: Jan. 16, 2025

(30) Foreign Application Priority Data
Jan. 30, 2024 (JP) 2024-011951

(51) Int. Cl. F16L 55/24

(52) U.S. Cl. CPC F16L 55/24

(57) ABSTRACT

A vent pipe end structure a vent pipe and pipe-end vent part. The vent pipe is provided in a structure of a vehicle. The pipe-end vent part is provided at an end of the vent pipe to inhibit entry of a foreign object. The pipe-end vent part has a three-dimensional shape. Slit-like vent holes are provided in at least a curved surface of the three-dimensional shape of the pipe-end vent part so as to extend radially from an end side of the pipe-end vent part to a base side of the pipe-end vent part.

### CROSS-REFERENCE TO RELATED APPLICATIONS

The present application claims priority from Japanese Patent Application No. 2024-011951 filed on Jan. 30, 2024, the entire contents of which are hereby incorporated by reference.

### BACKGROUND OF THE INVENTION

### Field of the Invention

The present invention relates to a vent pipe end structure.

### Description of Background Art

For example, Japanese Unexamined Patent Application Publication (JP-A) No. 2015-90094 describes a technique in which a cover member is attached to an opening of a vent pipe. The entire contents of this publication are incorporated herein by reference.

### SUMMARY OF THE INVENTION

According to one aspect of the present invention, a vent pipe end structure includes a vent pipe positioned in a structure of a vehicle, and a pipe-end vent part that is positioned at an end of the vent pipe and inhibits entry of a foreign object. The pipe-end vent part has a three-dimensional shape, and slit-like vent holes are formed in at least a curved surface of the three-dimensional shape of the pipe-end vent part and extending radially from an end side of the pipe-end vent part to a base side of the pipe-end vent part.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 schematically illustrates the configuration of a canister and a filter according to an embodiment;

FIG. 2 is a side view illustrating a state in which a vent cap is attached to a vent pipe of a filter case;

FIG. 3 is a right side view of FIG. 2;

FIG. 4A is a front view as viewed from arrow IVA in FIG. 2;

FIG. 4B is a front view of the vent pipe;

FIG. 5 is a sectional view taken along line V-V in FIG. 4A;

FIG. 6A is a sectional view taken along VIA-VIA in FIG. 4A;

FIG. 6B is a sectional view similar to FIG. 6A, but without a vent cap;

FIG. 7 is a side view illustrating a state in which a flat foreign object adheres to the vent cap; and

FIG. 8 is a sectional view corresponding to FIG. 6A according to an embodiment.

### DETAILED DESCRIPTION OF THE EMBODIMENTS

Embodiments will now be described with reference to the accompanying drawings, wherein like reference numerals designate corresponding or identical elements throughout the various drawings.

### First Embodiment

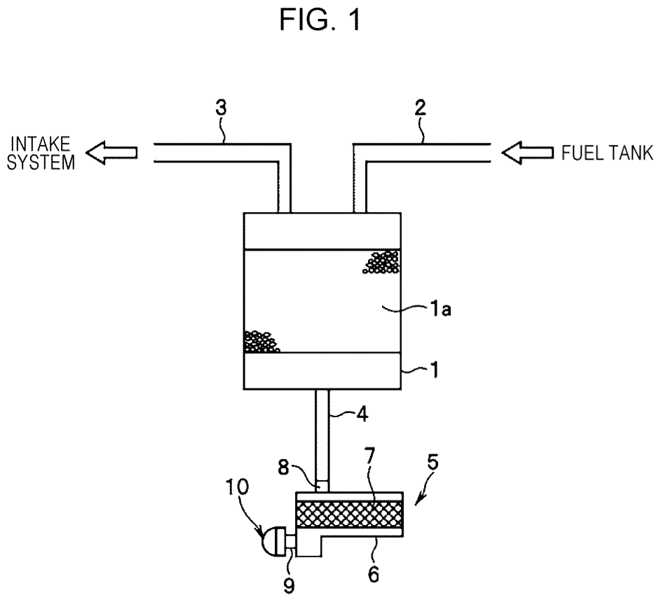

FIGS. 1 to 7 illustrate a first embodiment of the present invention. A downstream end of a fuel evaporation passage 2 and an upstream end of a purge passage 3 are coupled to a canister 1 illustrated in FIG. 1. An upstream end of the evaporation passage 2 communicates with an upper space of a fuel tank. A downstream end of the purge passage 3 communicates with an intake system downstream of a throttle valve.

The canister 1 is filled with activated carbon 1a, serving as an adsorbent. The activated carbon 1a adsorbs and desorbs evaporative gas generated in the fuel tank. The passages 2 and 3 and a base end of a drain passage 4 communicate with one another via the activated carbon 1a in the canister 1. A filter unit 5 is provided at a distal end of the drain passage 4.

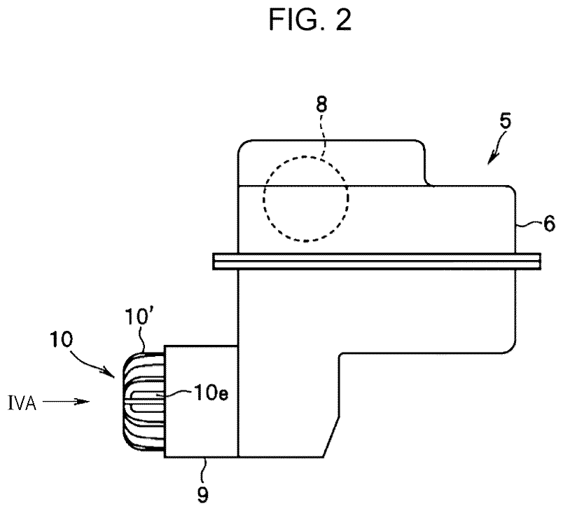

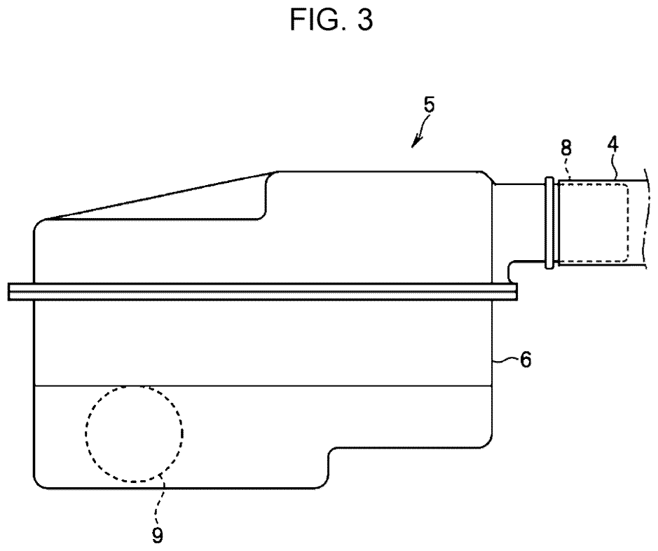

As illustrated in FIGS. 2 and 3, the filter unit 5 has a filter case 6. The filter case 6 is loaded with an air filter 7. A communication pipe 8 is formed on the filter case 6. The communication pipe 8 is coupled to the distal end of the drain passage 4. The canister 1 and the filter unit 5 serve as structures of the vehicle.

A vent pipe 9 is formed on the opposite side of the air filter 7 in the filter case 6 from the communication pipe 8. A pipe-end vent part 10 is provided at an open end of the vent pipe 9. The pipe-end vent part 10 is formed in the shape of a cap that is attachable to and detachable from the open end of the vent pipe 9. Hereinbelow, in this embodiment, the pipe-end vent part 10 is referred to as a vent cap 10 for convenience.

The canister 1 will be briefly described. When the internal pressure of the fuel tank increases, the evaporative gas flows into the canister 1 through the evaporation passage 2 due to the pressure difference and is adsorbed and trapped by the activated carbon 1a. At this time, the air in the activated carbon 1a passes through the drain passage 4 and the filter unit 5 and is discharged to the atmosphere.

Meanwhile, the evaporative gas adsorbed and trapped by the activated carbon 1a is purged in response to the intake negative pressure of the engine and is supplied to an intake system located downstream of the throttle valve through the purge passage 3. The evaporative gas supplied to the downstream side of the throttle valve is re-combusted with fresh air. At this time, due to the pressure difference in the canister 1, the outside air (air) is introduced into the canister 1 through the vent pipe 9 to regenerate the activated carbon 1a.

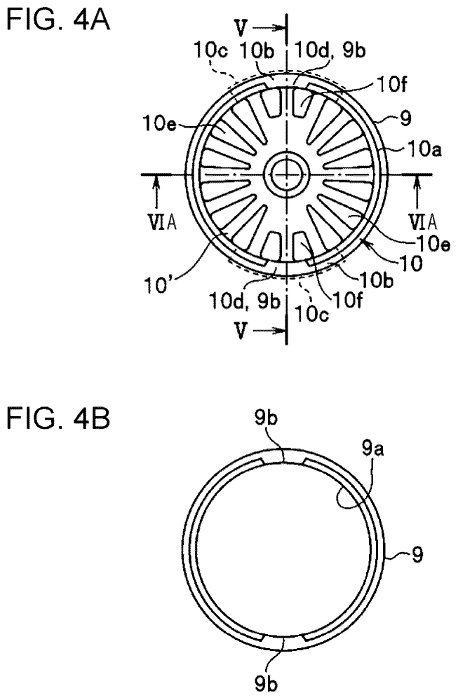

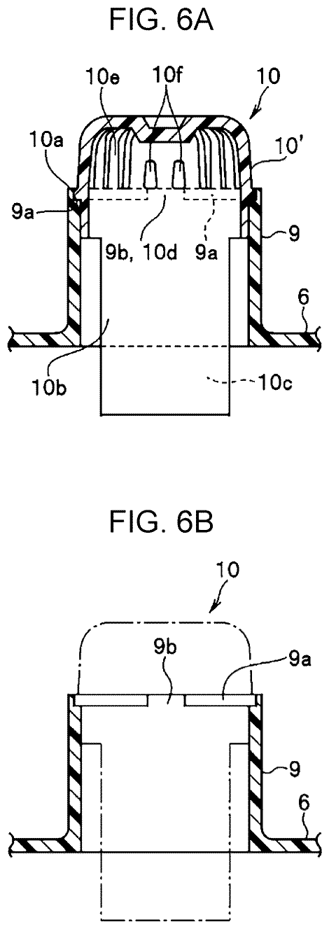

As illustrated in FIGS. 4B and 6B, a pair of steps 9a are formed on the inner circumference of the open end of the vent pipe 9. A pair of projections 9b are formed so as to be adjacent to the steps 9a. An upper part of a main body 10′ of the vent cap 10 is formed in a three-dimensional curved shape, which is an example of a three-dimensional bowl shape. The upper part of the main body 10′ may have a substantially dome-like three-dimensional curved shape.

Furthermore, the lower part of the main body 10′ is formed in an annular shape continuous with the upper part. The annular part of the main body 10′ has a size slightly smaller than or equal to the inner circumference of the vent pipe 9.

Furthermore, a flange 10a is formed in the vicinity of the boundary between the bowl-shaped part and the annular part of the main body 10′. The flange 10a is fitted with the steps 9a of the vent pipe 9. The outer circumference of the flange 10a has a size slightly smaller than or substantially equal to the inner circumference of the steps 9a. A bottom surface of the flange 10a is engaged with the steps 9a and thus is positioned in the attachment/removal direction.

A pair of levers 10b extend downward from the lower end of the main body 10′. The levers 10b are formed at the ends of the diameter of the main body 10′. Hooks 10c are formed at the lower parts of the levers 10b. The hooks 10c are formed on the outer circumferences of the levers 10b. Furthermore, the flange 10a has notches 10d at positions corresponding to the centers of the levers 10b in the width direction thereof. The notches 10d are formed at the same positions as the projections 9b. The notches 10d are shaped to be fitted with the projections 9b.

As illustrated in FIG. 4A, when the vent cap 10 is fitted to the vent pipe 9, the notches 10d and the projections 9b are aligned. By doing so, the notches 10d and the projections 9b are fitted together to restrict the movement of the vent cap 10 in the rotation direction. The notches 10d and the projections 9b correspond to a positioning part according to an embodiment of the present invention.

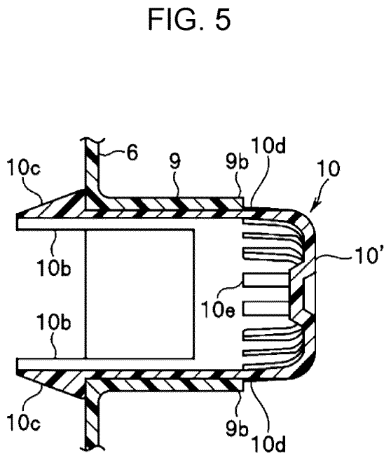

As illustrated in FIGS. 5 and 6A, when the vent cap 10 is attached to the vent pipe 9, the lower end of the flange 10a comes into contact with the steps 9a and thus is positioned in the attachment/removal direction. At the same time, the hooks 10c are engaged with an inner surface of the filter case 6 at the base of the vent pipe 9. In this way, the movement of the vent cap 10 in the attachment/removal direction with respect to the vent pipe 9 is restricted.

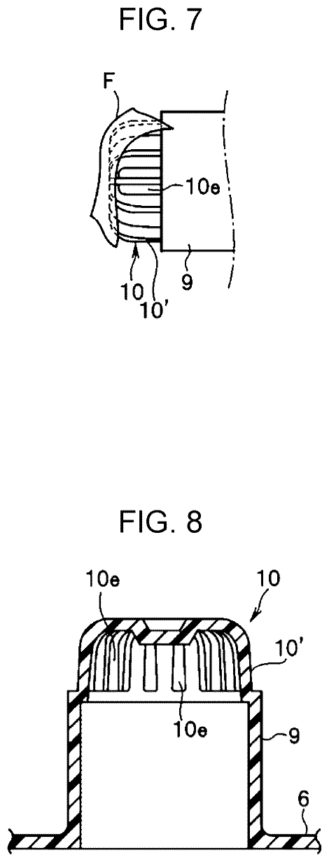

The main body 10′ has slit-like vent holes 10e extending radially from the top side (end side) to the flange 10a on the base side. Furthermore, two vent holes 10f are provided at positions corresponding to the notches 10d of the main body 10′. The vent holes 10f are provided at the same interval as the other vent holes 10e only at the lower parts thereof, and have a substantially trapezoidal shape with a short height. In FIG. 7, reference sign F denotes a flat foreign object such as paper or a leaf.

Next, the operation of this embodiment having the above-described configuration will be described.

When the vent cap 10 is fitted to the open end of the vent pipe 9, an operator visually checks the positions of the notches 10d provided in the vent cap 10. The vent holes 10f provided at the positions corresponding to the positions of the notches 10d are shorter than the other vent holes 10e. Hence, by visually checking the vent holes 10f, the positions of the notches 10d can be easily recognized.

Then, the operator inserts the levers 10b of the vent cap 10 along the inner circumference of the vent pipe 9. At this time, the operator attaches the vent cap 10 to the vent pipe 9 in a state in which the notches 10d are aligned with the projections 9b formed at the steps 9a of the vent pipe 9.

By doing so, when the lower end of the flange 10a formed on the vent cap 10 is brought into contact with the steps 9a formed on the vent pipe 9, the notches 10d are fitted with the projections 9b. This restricts the movement of the vent cap 10 in the rotation direction. When the lower end of the flange 10a is brought into contact with the steps 9a, the hooks 10c formed on the levers 10b of the vent cap 10 are engaged with the inner surface of the filter case 6. This restricts the movement of the vent cap 10 in the attachment/removal direction. As a result, as illustrated in FIGS. 2, 5 and 6A, the vent cap 10 is fixed to the open end of the vent pipe 9.

When the evaporative gas adsorbed by the activated carbon 1a in the canister 1 is purged to the intake system, the air of an amount corresponding to the amount of the purged evaporative gas flows into the canister 1. The air passes through the vent holes 10e and 10f provided in the main body 10′ of the vent cap 10 and flows through the air filter 7 loaded in the filter case 6.

The air filter 7 removes dust and the like contained in the air flowing into the canister 1 through the vent holes 10e and 10f. Furthermore, a flat foreign object F, such as paper or a leaf, blown up when the vehicle is traveling adheres to the front face of the main body 10′, as illustrated in FIG. 7, without passing through the vent holes 10e and 10f. Hence, the flat foreign object F does not enter the filter case 6.

Furthermore, as illustrated in FIG. 7, the vent holes 10e and 10f are provided in a three-dimensional shape so as to extend radially from the top of the main body 10′ along the side surface thereof. Hence, even if a flat foreign object F adheres to the front face of the main body 10′, not all the vent holes 10e and 10f are closed. Hence, the vent cap 10 can always allow air to pass therethrough.

The vent holes 10e and 10f are formed in the shape of three-dimensional curved slits extending along the shape of the main body 10′. Hence, the vent holes 10e and 10f have relatively large opening areas, and the dust is less likely to accumulate on the vent holes 10e and 10f. Accordingly, the vent holes 10e and 10f are not clogged by the accumulated dust.

As described above, according to this embodiment, the slit-like vent holes 10e extend from the top side of the main body 10′ to the flange 10a on the base side. Furthermore, the vent holes 10e and 10f are formed radially in the main body 10′. Hence, the vent holes 10e and 10f have relatively large opening areas, allowing the outside air to be introduced into the filter case 6 with a small air resistance.

Furthermore, the vent holes 10e and 10f are formed in the shape of three-dimensional curved slits extending along the shape of the main body 10′. Hence, even if a foreign object F blown up when the vehicle is traveling adheres to the main body 10′, not all the vent holes 10e and 10f are clogged. Thus, passage of air is constantly ensured.

The vent holes 10e are formed in a slit shape extending from the top side to the base side. Hence, the opening areas of the vent holes 10e and 10f are relatively large, and the dust is less likely to accumulate. Hence, the vent holes 10e and 10f are not clogged by the accumulated dust, which provides high reliability.

The vent cap 10 is attachable to and detachable from the vent pipe 9 of the filter case 6. Hence, the vent cap 10 can be replaced with an existing vent cap, which provides high versatility. Furthermore, the vent cap 10 can be easily replaced, which provides good maintainability.

Furthermore, the flange 10a of the main body 10′ is provided with the notches 10d, and the projections 9b to fit to the notches 10d are formed on the vent pipe 9. Hence, by fitting the notches 10d and the projections 9b, the movement of the vent cap 10 in the rotation direction can be restricted by a one-touch operation.

The vent holes 10f provided at the positions corresponding to the positions of the notches 10d are shorter than the other vent holes 10e. Hence, the operator can easily recognize the positions of the notches 10d by visually checking the positions of the vent holes 10f.

Furthermore, the positions of the hooks 10c formed on the levers 10b of the vent cap 10 are aligned with the positions of the notches 10d in the axial direction. Hence, for example, when the vent cap 10 is removed from the vent pipe 9, the operator can easily estimate the positions of the hooks 10c by recognizing the positions of the notches 10d or the vent holes 10f. As a result, the operator can easily attach and detach the vent cap 10, which increases the working efficiency.

Furthermore, because the structure is simple, in which the main body 10′ has the flange 10a and the radially provided vent holes 10e and 10f, manufacturing is easy. Furthermore, because the slit-shaped vent holes 10e and 10f are provided along the three-dimensional curved surface of the main body 10′, only two-directional molding is performed. Thus, molding is easy.

### Second Embodiment

FIG. 8 illustrates a second embodiment of the present invention. In this embodiment, the pipe-end vent part 10 and the vent pipe 9 of the filter case 6 are formed as a single component.

Hence, the pipe-end vent part 10 of this embodiment does not have the flange 10a and the levers 10b, which are provided on the vent cap 10 of the first embodiment. Furthermore, in the main body 10′ of the pipe-end vent part 10, the part corresponding to the flange 10a and the portion therebelow in the first embodiment is unnecessary, and this part is formed continuous with the vent pipe 9.

According to this embodiment, because the pipe-end vent part 10 and the vent pipe 9 are formed as a single component, the step of assembling the pipe-end vent part 10 with respect to the vent pipe 9 can be omitted.

A vent pipe end structure according to an embodiment of the present invention includes, as a structure of a vehicle: a filter case; and a canister that adsorbs and desorbs fuel evaporative gas generated in a fuel tank. The canister and a vent pipe communicate with each other with an air filter of the filter case interposed therebetween.

The present invention is not limited to the above-described embodiments, and the main body 10′ may be formed in a three-dimensional shape, such as a cylindrical shape or a conical shape.

According to an embodiment of the present invention, the pipe-end vent part is formed in a three-dimensional shape, and the slit-like vent holes are formed at least in the curved surface thereof so as to extend radially from the end side to the base side. Hence, the structure simple, and the atmospheric air can be introduced to the structure side with a small air resistance.

A vehicle, such as an automobile, is provided with a canister for preventing fuel evaporative gas generated in a fuel tank from being discharged to the atmosphere. The canister is filled with an adsorbent (activated carbon) for adsorbing and desorbing the evaporative gas. When the internal pressure of the fuel tank increases, the evaporative gas is adsorbed and trapped by the adsorbent due to the pressure difference. As a result, the air in the adsorbent is released to the atmosphere through a vent pipe. The evaporative gas adsorbed by the adsorbent is purged in response to the intake negative pressure of an engine and is re-combusted together with fresh air. When the evaporative gas is purged from the adsorbent, outside air (air) flows into the canister through the vent pipe provided in a structure of a vehicle to regenerate the adsorbent.

In addition, a vent slit or a mesh is provided at an open end of the vent pipe. This vent slit or mesh is mainly intended to prevent the open end from being clogged by bugs, such as spiders. However, a flat foreign object, such as a leaf blown up when the vehicle is traveling, may adhere to and clog the open end. Furthermore, when dust accumulates on the mesh, the dust builds up to cause clogging.

For example, Japanese Unexamined Patent Application Publication (JP-A) No. 2015-90094 describes a technique in which a cover member is attached to an opening of a vent pipe. In this document, first vent slits are provided in side surfaces of an open end of the vent pipe, second vent slits intersecting the first vent slits are provided in side surfaces of a cover member, and vent holes are provided in a front surface of the cover member.

In this technique, even if the vent holes in the front surface of the cover member are clogged by an accumulated flat foreign object or dust, air can be introduced through the second vent slits provided in the side surfaces of the distal end section into a canister via the first vent slits.

The technique described in JP-A No. 2015-90094 uses a two-layer structure, in which the first vent slits are provided in the side surfaces of the open end of the vent pipe and the second vent slits are provided in the cover member attached to the open end, which is complicated.

In addition, this technique uses a labyrinth structure, in which the first and second vent slits are intersecting. This increases the air resistance occurring when the atmospheric air is introduced to the filter, thus making it difficult to sufficiently purge the evaporative gas.

It is desirable to provide a vent pipe end structure capable of introducing atmospheric air to a structure of a vehicle with small air resistance and with a simple structure.

An aspect of the present invention provides a vent pipe end structure including a vent pipe and pipe-end vent part. The vent pipe is provided in a structure of a vehicle. The pipe-end vent part is provided at an end of the vent pipe to inhibit entry of a foreign object. The pipe-end vent part has a three-dimensional shape. Slit-like vent holes are provided in at least a curved surface of the three-dimensional shape of the pipe-end vent part so as to extend radially from an end side of the pipe-end vent part to a base side of the pipe-end vent part.

Obviously, numerous modifications and variations of the present invention are possible in light of the above teachings. It is therefore to be understood that within the scope of the appended claims, the invention may be practiced otherwise than as specifically described herein.

1. A vent pipe end structure, comprising:
a vent pipe positioned in a structure of a vehicle; and
a pipe-end vent part positioned at an end of the vent pipe and configured to inhibit entry of a foreign object,
wherein the pipe-end vent part has a three-dimensional shape, and slit-like vent holes are formed in at least a curved surface of the three-dimensional shape of the pipe-end vent part and extending radially from an end side of the pipe-end vent part to a base side of the pipe-end vent part.

2. The vent pipe end structure according to claim 1, wherein the three-dimensional shape is a three-dimensional curved shape.

3. The vent pipe end structure according to claim 1, wherein the pipe-end vent part is attachable to and detachable from the end of the vent pipe, and a hook configured to be inserted into the vent pipe and engaged with the structure is formed on the base side of the pipe-end vent part.

4. The vent pipe end structure according to claim 3, wherein the vent pipe has a step on an inner circumference thereof, a flange configured to be fitted to the step is formed on an outer circumference of the pipe-end vent part, and the step and the flange are formed with positioning parts respectively, the positioning parts being configured to be fitted together to restrict movement in a rotation direction.

5. The vent pipe end structure according to claim 1, wherein the pipe-end vent part and the end of the vent pipe are formed as a single component.

6. The vent pipe end structure according to claim 2, wherein the pipe-end vent part is attachable to and detachable from the end of the vent pipe, and a hook configured to be inserted into the vent pipe and engaged with the structure is formed on the base side of the pipe-end vent part.

7. The vent pipe end structure according to claim 6, wherein the vent pipe has a step on an inner circumference thereof, a flange configured to be fitted to the step is formed on an outer circumference of the pipe-end vent part, and the step and the flange are formed with positioning parts respectively, the positioning parts being configured to be fitted together to restrict movement in a rotation direction.

8. The vent pipe end structure according to claim 2, wherein the pipe-end vent part and the end of the vent pipe are formed as a single component.

9. The vent pipe end structure according to claim 3, wherein the pipe-end vent part and the end of the vent pipe are formed as a single component.

10. The vent pipe end structure according to claim 4, wherein the pipe-end vent part and the end of the vent pipe are formed as a single component.
